(19) United States
(12) Patent Application Publication
(10) Pub. No.: US 2010/0245892 A1
(43) Pub. Date: Sep. 30, 2010

(54) Printing Method for Screen Image

(75) Inventor: Daisuke Takahashi, Broomfield, CO (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 12/416,137

(22) Filed: Mar. 31, 2009

(51) Int. Cl. G06F 15/00

(52) U.S. Cl. 358/1.15

(57) ABSTRACT

Disclosed is a computer implemented printing method to print on a sheet an image of an object of which data is placed in a clipboard of a computer, the method including the procedures of: the computer activating a printing program installed in the computer; the printing program automatically retrieving the data of the object from the clipboard; the printing program requesting a printer driver installed in the computer to generate a print job to print an image of the object based on the data retrieved from the clipboard; the printer driver transmitting the print job to the printer; and the printer printing the image of the object on the sheet according to the print job.

### BACKGROUND OF THE INVENTION

1. Field of the Invention

The present invention relates to printing method in a computer system. In more particular, the present invention relates to printing method for printing an image based on object temporarily stored in a software facility, typically called “clipboard.”

2. Description of Related Art

In a computer system, an operating system (OS), such as Microsoft Windows®, Mac OS®, and windowing applications such as the X Window System and the like, is commonly used to interface between hardware and application programs. As widely acknowledged such OS is responsible for the management and coordination of activities and the sharing of the resources of the computer. An OS also provides a number of services to application programs; application programs access to such services through application program interfaces (APIs) or system calls.

One typical example of such services is the one so called “clipboard.” This service is a temporary storage service that facilitates storage of an object, such as a text data of text string with or without typeface thereof, bitmap image data, and even more complex data such as spreadsheet and database entries. By using the clipboard functionality, an application program can move or copy the object in a file to a different location of the file. An object placed in the clipboard by a certain application program can be retrieved by a different application program so that the different application program can use the object with or with out metadata information.

Another example of using the clipboard functionality is a service so called “screen shot” or “screen capture”, which is for capturing a whole or part of a screen image displayed on a computer monitor. Sometimes a user of such computer system captures the screen image through the clipboard functionality to obtain a hard copy of the screen image.

However, regardless of the type of object placed in the clipboard, the procedure to obtain the hard copy of an image of the object usually requires a user to follow some steps. For example, the procedure requires the user to follow serial steps of: placing an object to be printed, such as the screen image, in the clipboard, retrieving and pasting the object on an empty sheet prepared by an application program, such as Microsoft Office Word™, Microsoft Office Excel™ or the like; and then calling print service from the application program to print the image of the object.

In this case, the user needs to manipulate the computer system to prepare the empty sheet, to paste the object on the empty sheet, and sometimes to position and re-size the object pasted on the empty sheet; these steps are deemed to be troublesome when he/she wants to obtain the image as a hard copy quickly or instantly.

Further, in case where the user only wants the hard copy of the object, he/she does not intend to store the sheet. Even such case the data of the sheet remains in the computer after the printing on the image, and therefore, the user will needs to conduct another step for deleting the data of the sheet.

In this regard, it should be said the conventional computer systems failed to provide a user with a user-friendly print scheme.

### SUMMARY

The present invention includes one perspective to provide a novel print scheme that can ease the user's burden to obtain an image of an object that the user needs. In more specifically, the present invention may provide an instant user-friendly print scheme that can remove or lessen the drawbacks in the abovementioned conventional print scheme.

(1) To attain the above-mentioned perspective or other perspective, a computer implemented printing method embodied in accordance with one aspect of the present invention is for printing on a sheet an image of an object of which data is placed in a clipboard of a computer. The computer implemented method may comprise: activating a printing program installed in the computer; the printing program automatically retrieving the data of the object from the clipboard; the printing program requesting a printer driver installed in the computer to generate a print job to print an image of the object based on the data retrieved from the clipboard; the printer driver transmitting the print job to the printer; and the printer printing the image of the object on the sheet according to the print job.

(2) In the item (1), it is preferably that the printing program determines if the data of the object exists in the clipboard before retrieving the data from the clipboard.

(3) In the item (2), it is also preferable that the printing program alerts a user in a case where the printing program determines that the data of the object does not exist in the clipboard.

(4) In the item (1), it is preferable that the printing program requests the printer driver to print the image of the object in accordance with print conditions set in the printing program.

(5) In the item (4), the method preferably further comprises: the printing program displaying at least one instruction screen on the computer monitor, wherein the print conditions set in the printer program may be inputted through the at least one instruction screen.

(6) In the item (5), it is preferable that the at least one instruction screen includes a first instruction screen and a second instruction program, wherein the second instruction screen is preferably able to be displayed through a user instruction initiated on the first instruction screen.

(7) In the item (1), it is preferable that the printing program displays on the computer monitor an image of the object of which data is retrieved from the clipboard before requesting the printer driver to generate the print job.

(8) In the item (5), it is preferable that the printing program alerts a user if the printer has no capability to satisfy the print conditions designated through the at least one instruction screen.

(9) In the item (1), it is preferable that the printing program selects either of a color printing or a black and white printing, in accordance with whether the data of the object retrieved from the clipboard includes color information or not.

### BRIEF DESCRIPTION OF THE DRAWINGS

FIGS. 1(a) and 1(b) show computer systems of an embodiment of the present invention.

FIG. 2 shows a schematic diagram of the configuration inside a computer 2 according to an embodiment.

FIG. 3 shows a schematic diagram of the configuration inside a printer 3 according an embodiment.

FIG. 4 shows a flowchart of a printing procedure according to an embodiment.

FIG. 5 shows an example of the instruction screen.

FIG. 6 shows an example of the optional instruction screen.

FIG. 7 shows an example of image confirmation screen.

### DETAILED DESCRIPTION OF THE PREFERRED EMBODIMENTS

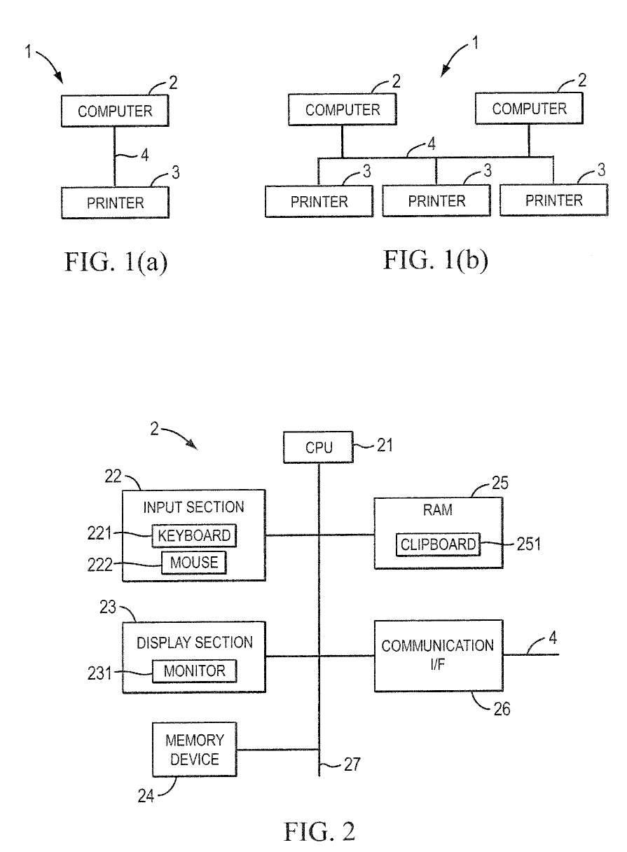

FIGS. 1(a) and 1(b) each show a computer system 1 of an exemplary embodiment of the present invention. The computer system 1 includes a computer 2 and at least one printer 3 which are connected each other by a data communication line 4. The data communication line can be an independent line (FIG. 1(a)), such as a bidirectional parallel bus, a USB® (Universal Serial Bus) or the like, or can be a network (FIG. 1(b)), such as Ethernet, FDDI (Fiber-Distributed Data Interface) or the like, so as to communicate with each other.

### (Configuration Inside the Computer 2)

FIG. 2 shows schematic diagram of configuration inside the computer 2 in the computer system 1. The configuration inside the computer 2 will be described with referring to FIG. 2.

The computer 2 includes a CPU 21, an input section 22, a display section 23, a memory device 24, a RAM 25 and communication I/F 26. These devices are connected with an internal bus 27.

The CPU 21 controls entire sections of the computer 2 and executes various programs including an operating system (OS) and application programs. As apparent from below, the CPU 21 achieves various functions in accordance with the OS and application programs with using the RAM as a work area thereof. The input section 22 is composed of a keyboard 221, a mouse 222 or the like with which instructions to the CPU 21 is inputted from a user.

The display section 23 is represented by the computer monitor 231 which displays various types of information thereon including the instruction screens for printing according to an embodiment of the present invention, to be described later.

The memory device 24 such as a hard disk stores the OS and various application programs including the clipboard print program according to the embodiment of the present invention.

The RAM 25 works as a work area of the CPU 21 to execute the OS and application programs stored in the memory device 24. The CPU 21 also uses the RAM 25 to store various types of information therein to carry out various services. This RAM 25 includes a temporary memory area for a clipboard 251 as a service given by the OS. As discussed below, the present embodiment provides a novel print scheme to print an image of an object as quickly as possible by retrieving data of the object from the clipboard 251 and transmitting a print data created based on the object data to the printer 3.

The communication I/F 26 is provided to communicate with the printer 3 through the independent line (FIG. 1(a)) or a network (FIG. 1(b)) as the data communication line 4.

### (Configuration Inside the Printer 3)

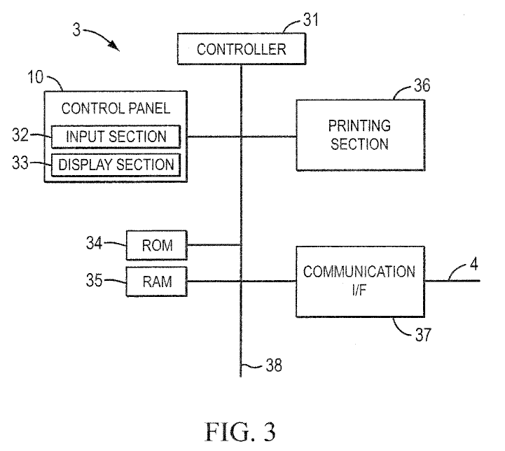

FIG. 3 shows a schematic diagram of the configuration inside the printer 3 in the computer system 1 according to one embodiment of the present invention. The configuration inside the printer 3 will be described with referring to FIG. 3.

The printer 3 includes a controller 31, an input section 32, a display section 33, a ROM 34, a RAM 35, a printing section 36, and a communication I/F 37. These devices are connected with an internal bus 38.

The input section 32 is provided in a control panel 10 on the printer 3 and used for inputting instructions to the controller 31 or for configuring the print conditions of the printer 3.

The display section 33 is also provided in the control panel 10 on the printer 3 to display various types of information thereon such as the configured conditions or current operation status of the printer 3.

As memories, ROM 34 and RAM 35 are provided in the printer 3 as a permanent storage of operational programs and as a temporary storage of data or instructions.

The printing section 36 is composed of hardware devices actuated by the controller 31 to form an image on a sheet.

The communication I/F 37 is provided to communicate with the computer 2 through the independent line (FIG. 1 (a)) or the network (FIG. 1(b)) as the data communication line 4. The computer 2 transmits print job including data of an object and instruction data to the printer 3 through the bus 4.

### (Procedure for Printing)

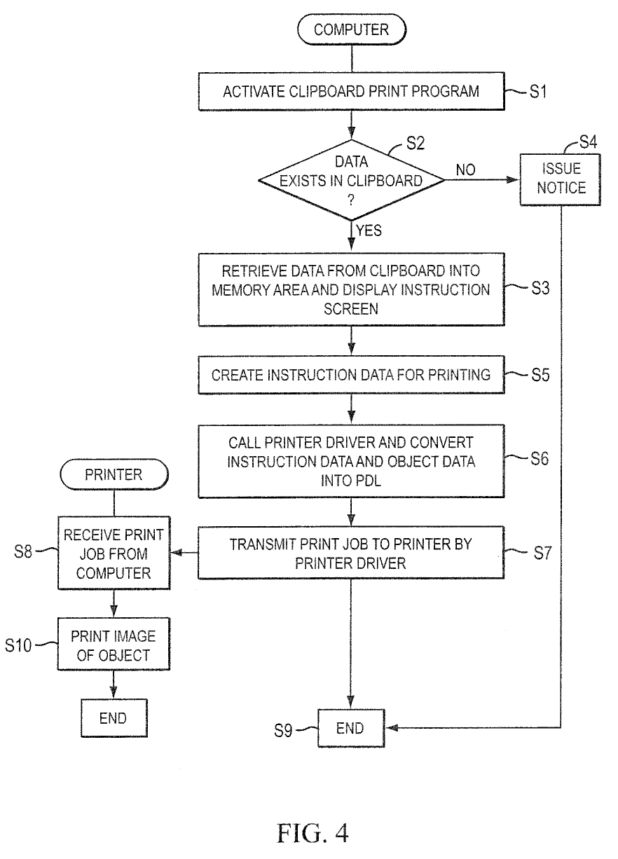

The procedure to print an image of an object placed in the clipboard 251 by the printer according to the printing system of an embodiment will be described next with referring to FIG. 4 that shows a flowchart of a printing procedure according to an embodiment of the present invention. Note that the following explanation is made with using a case where the object to be printed is a screen image displayed on the computer monitor 231.

First of all, the data of the desired screen image displayed on the computer monitor 231 in the display section 23 is temporally stored in the clipboard 251 in RAM 25 by using a well known screen shot functionality. The screen shot functionality may be provided by the OS as one of the services thereof, or by an application program running on the OS. One of the methods to store the data of the screen image in the clipboard 251 is use of “Print Screen” button on the computer keyboard 221 in the input section 22. When the button is depressed, the screen image currently displayed on the computer monitor 231 is stored as data of an object in the clipboard 251.

As mentioned above, although the screen image is exemplary used as the object to be printed, the present invention is not limited to the case where the screen image is placed in the clipboard 251. Another method to place an object in the clipboard 251 includes cutting or copying a text string in a word processing program, for instance. This can be initiated with dragging a cursor on a text line on the screen of the word processing program displayed on the computer monitor 231 with the mouse 222 to identify a desired area of the text line. The dragged area becomes a block in which colors are reversed. Next, a cut or copy command is instructed by the user through the application program, so that the data of the desired text string is stored in the clipboard 251.

Returning again to FIG. 4, as the next step, the clipboard print program of the present embodiment is activated (Step S1). For instance, this is achieved by a user to click a specific icon on the desktop screen displayed on the computer monitor 231, where the specific icon is prepared to activate or initiate the clipboard print program. However, activating the clipboard print program may be accomplished in various ways and is not limited to the use of an icon and another method can be used.

Then judgment whether data exists in the clipboard 251 or not is conducted (Step S2). In one hand, if the data exists in the clipboard 251 (Step S2: YES), the data is retrieved from the clipboard 251 into a memory area allocated to the clipboard print program, and an instruction screen 11 is displayed (Step S3). On the other hand, if no data exists in the clipboard 251 (Step S2: NO), a notice is issued to inform the user of the absence of data in the clipboard (Step S4) and ends the program (Step S9).

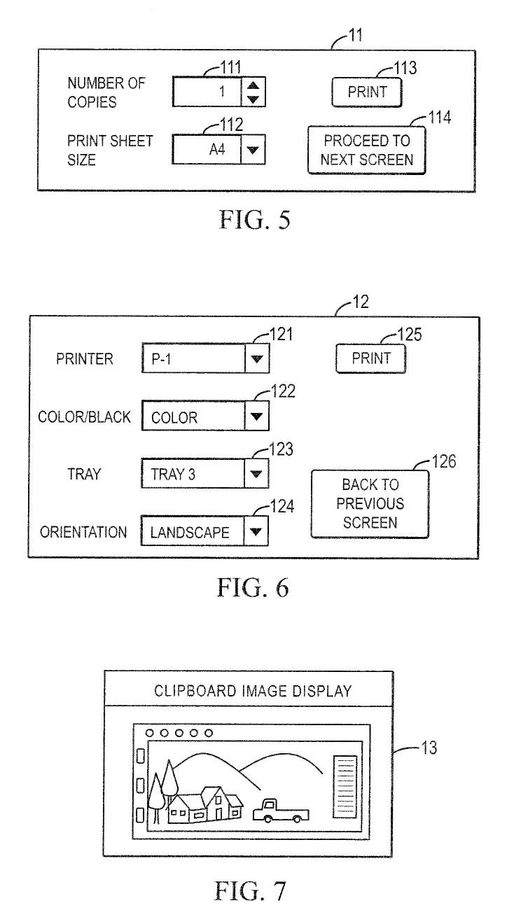

FIG. 5 shows an example of the instruction screen 11. This instruction screen 11 is a screen for inputting instruction information to setup instruction data to be sent to the printer 3 for controlling the printer 3. Only some fundamental settings or selections for determining the printing condition are inputted through the instruction screen 11 to create instruction data (Step S5).

Should the dominant purpose of providing this clipboard print program be simplifying the procedure and minimizing the time to be spent for printing, the instruction screen 11 to be displayed first on the screen 231 is preferable to include minimum necessary items for instruction. Therefore, in this exemplary embodiment, the instruction screen 11 includes only number of copies 111 and sheet size 112 such as “1 copy” and “A4 size” as the selection items, both of which have been set as defaults as shown in FIG. 5. The instruction screen 11 includes further a button for printing 113 in order to instruct starting of printing in the printer 3 and a proceeding button 114 for proceeding to an optional instruction screen 12 which will be described later.

The minimum necessary input items are selected on the instruction screen 11 at the designing stage of the clipboard print program so that the user can input instruction data quickly and easily and can minimize the time to spend until the start of printing.

The size of printed image can be automatically adjusted according to the size of the selected sheet and a size of the object, in case of the data of the object includes information relating to a dimension of the object. For instance, in case where the object is a bitmap image, from the data of the object the dimensions of the bitmap image can be understood from the number of horizontal and vertical pixel and the print resolution of the target printer. Further the orientation of the printed image can be automatically determined according to the sheet orientation as default setting. Of course, contents of the default can be changed by the user.

To minimize the time the user spends until printing, these items have been set to one among some options as default, however the user can change the preset values according to demand. For example if the increment or decrement button (in this case a triangle or an inverted triangle button) is clicked, other options appear for the user to select another.

As exemplary illustrated in FIG. 6, the optional instruction screen 12 includes, for example, printer name list 121, color/black 122, sheet feeding tray 123, orientation of image 124, and others as the selection items. This optional instruction screen can be optional. The optional instruction screen 12 also includes a printing button 125 in order to instruct starting of printing in the printer 3 and a back button 126 for backing to the instruction screen 11. If a further optional instruction screen is available, the optional instruction screen 12 may include a proceeding button for proceeding to the further optional instruction screen.

In the printer name list 121, one printer 3 has been selected as a default; however, of course the user can choose another printer name in the list 121. The default printer in the list 121 can be set among the available printers in accordance with the default printer setting in the OS.

Not only the printer list but also the above-mentioned items such as color/black 122, sheet feeding tray 123, orientation of image 124 have been set to one of the options as default, however the user can change the preset values according to demand.

An example of combination of instruction screens 11 and 12 are described above, however the configuration of instruction screens are not limited to the above, for example the selection items can be divided into more instruction screens which appears sequentially.

In the Step 5, for a confirmation purpose, it can be configured so that the images stored as data in the clipboard can be viewed in a confirmation screen 13 on the monitor 231 as a thumbnail image, for example, before issuing instruction of printing. FIG. 7 shows an example of image confirmation screen 13. In this case, the image is retrieved from the clipboard 251 at this moment or has been retrieved in advance.

It can be configured so that if the printer designated through the instruction screen does not have the capabilities instructed through the instruction screen, a notice can be displayed to the computer monitor 231. For example, when color printing is set as default and a printer having no color print capability is designated through the instruction screen 12, a notice asking the user whether black and white printing is acceptable or not appeared on the monitor 231.

Further, it can be configured so that if the data of the object in the clipboard 251 includes color information, such as the screen image obtained by screen shot functionality, color printing is automatically selected, and if the data in the clipboard does not include color information, black and white printing is selected according to a usual demand of users. As is often the case, for text printing, the black and white printing satisfies the user's demand.

After the instruction data created through the instruction screen 11 and/or instruction screens, a printer driver corresponding to the selected printer is called. The printer driver converts the instruction data and the object data retrieved from the clipboard 251 in step 3 into a form of a PDL (Page Description Language) as a print job (Step S6).

Next, the printer driver transmits the print job to the printer 3 through the data communication line 4 (Step S7).

After executing Step 7, the clipboard print program may be spontaneously closed. In this closing procedure, the clipboard print program may clear the clipboard 251 by putting null data to the clipboard, for the purpose of security. Whether clearing the clipboard or not may be set by the user. The printer 3 receives the transmitted print job (Step S8) and parses and rasterizes the same to generate printable bitmap image data in accordance with the print condition included in the print job. The printer then prints the object images on sheets (Step S10). The number of hard copies to be formed by the printer is set by the information on the print condition included in the print job, which is generated in accordance with the instruction data set in the clipboard print program.

In accordance with the clipboard print program of the present embodiment, the clipboard functionality can be exploited for the purpose of printing. For instance, by using the Print Screen button, object data from many different windows displayed on the computer monitor can be placed in the clipboard 251 and an image of these clipboard objects can be printed on a single sheet. In case of divided window images are displayed by the window dividing function of Microsoft Office Word, a single image containing the divided window images can be printed on a single sheet quickly and easily. This hard copy output could not be obtained from the conventional printing scheme initiated from the Microsoft Office Word.

Although the present invention has been illustrated and described with reference to the exemplified embodiments of the present invention, the present invention is not limited thereto. It should be understood that various changes and modifications can be made thereto without departing from the spirit and scope of the present invention.

For instance, although the clipboard print program is configured so as to be able to choose an appropriate printer among available printers, this program can be exclusive for a certain printer. In this case, the clipboard print program can be shipped together with print driver of the certain printer as a utility software program, so that an install program for the printer driver may install the utility software on the intended computer at the same time.

1. A computer implemented printing method to print on a sheet an image of an object of which data is placed in a clipboard of a computer, the method comprising:
activating a printing program installed in the computer;
the printing program automatically retrieving the data of the object from the clipboard;
the printing program requesting a printer driver installed in the computer to generate a print job to print an image of the object based on the data retrieved from the clipboard;
the printer driver transmitting the print job to the printer; and
the printer printing the image of the object on the sheet according to the print job.

2. The printing method of claim 1, wherein the printing program determines if the data of the object exists in the clipboard before retrieving the data from the clipboard.

3. The printing method of claim 2, wherein the printing program alerts a user in a case where the printing program determines that the data of the object does not exist in the clipboard.

4. The printing method of claim 1, wherein the printing program requests the printer driver to print the image of the object in accordance with print conditions set in the printing program.

5. The printing method of claim 4, further comprising:
the printing program displaying at least one instruction screen on the computer monitor; and,
wherein the print conditions set in the printer program are inputted through the at least one instruction screen.

6. The printing method of claim 5,
wherein the at least one instruction screen includes a first instruction screen and a second instruction screen, and
wherein the second instruction screen is able to be displayed through a user instruction initiated on the first instruction screen.

7. The printing method of claim 1,
wherein the printing program displays on the computer monitor an image of the object of which data is retrieved from the clipboard before requesting the printer driver to generate the print job.

8. The printing method of claim 5,
wherein the printing program alerts a user if the printer has no capability to satisfy the print conditions designated through the at least one instruction screen.

9. The printing method of claim 1,
wherein the printing program selects either of a color printing or a black and white printing, in accordance with whether the data of the object retrieved from the clipboard includes color information or not.

10. A computer readable medium provided with a printing program which is executable by a computer capable of placing data of an object in a clipboard, the printing program being activated and executed by the computer to conduct steps comprising:
automatically retrieving the data of the object from the clipboard; and
requesting a printer driver installed in the computer to generate a print job to print an image of the object based on the data retrieved from the clipboard.

11. The medium of claim 10, wherein the printing program determines if the data of the object exists in the clipboard before retrieving the data from the clipboard.

12. The medium of claim 11, wherein the printing program alerts a user in a case where the printing program determines that the data of the object does not exist in the clipboard.

13. The medium claim 10, wherein the printing program requests the printer driver to print the image of the object in accordance with print conditions set in the printing program.

14. The medium of claim 10, wherein the printing program further executes:
displaying at least one instruction screen on the computer monitor; and
wherein the print conditions set in the printer program are inputted through the at least one instruction screen.

15. The medium of claim 14,
wherein the at least one instruction screen includes a first instruction screen and a second instruction screen, and
wherein the second instruction screen is able to be displayed through a user instruction initiated on the first instruction screen.

16. The medium of claim 10,
wherein the printing program displays on the computer monitor an image of the object of which data is retrieved from the clipboard before requesting the printer driver to generate the print job.

17. The medium of claim 10,
wherein the printing program selects either of a color printing or a black and white printing, in accordance with whether the data of the object retrieved from the clipboard includes color information or not.
